(19) United States
(12) Patent Application Publication
(10) Pub. No.: US 2023/0067603 A1
(43) Pub. Date: Mar. 2, 2023

(54) APPARATUS FOR GENERATING AN AEROSOL

(71) Applicant: Nicoventures Trading Limited, London (GB)

(72) Inventor: Walid ABI AOUN, London (GB)

(21) Appl. No.: 17/760,214

(22) PCT Filed: Feb. 9, 2021
(86) PCT No.: PCT/GB2021/050296

§ 371 Date: Aug. 5, 2022

(30) Foreign Application Priority Data
Feb. 26, 2020 (GB) 2002714.0

(51) Int. Cl. A24F 40/30; A24F 40/57; A24F 40/10; A24F 40/46

(52) U.S. Cl. CPC A24F 40/30; A24F 40/57; A24F 40/10; A24F 40/46

(57) ABSTRACT

An apparatus for generating an aerosol for inhalation by a user. The apparatus includes a first container for containing a liquid from which, in use, the apparatus generates a flow of aerosol; a second container for containing a material through which, in use, the flow of aerosol passes; an aerosol generating arrangement for generating the flow of aerosol from the liquid contained in the first container; and a heating arrangement for heating the material contained in the second container. The heating arrangement is arranged to heat the material contained in the second container to a temperature that prevents or reduces condensation from the flow of aerosol forming on the material and is below a temperature required to cause substantial aerosol formation from the material. A method of using such an apparatus is also disclosed.

### PRIORITY CLAIM

The present application is a National Phase entry of PCT Application No. PCT/GB2021-050296, filed Feb. 9, 2021, which claims priority from United Kingdom Application No. 2002714.0, filed Feb. 26, 2020, each of which is hereby fully incorporated herein by reference.

### TECHNICAL FIELD

The present disclosure relates to an apparatus for generating an aerosol.

### BACKGROUND

Smoking articles such as cigarettes, cigars and the like burn tobacco during use to create tobacco smoke.

Attempts have been made to provide alternatives to these articles that burn tobacco by creating products that release compounds without burning.

Examples of such products are heating devices which release compounds by heating, but not burning, the material. The material may be for example tobacco or other non-tobacco products, which may or may not contain nicotine.

As another example, there are so-called e-cigarette devices. These devices contain an aerosolizable substance, typically a liquid, which is heated to be vaporized to produce an inhalable vapor or aerosol. The liquid may contain nicotine and/or flavorings and/or aerosol-generating substances, such as glycerol. Such known e-cigarette devices typically do not contain or use tobacco.

As yet another example, there are so-called hybrid devices. These hybrid devices typically contain separately an aerosolizable substance, again typically a liquid, and a container for a material. In typical examples the material may be tobacco or other flavor material. The liquid is aerosolized to produce an inhalable vapor or aerosol which passes through the container for a material so that a property, such as a flavor, is imparted to the vapor or aerosol by the material before being inhaled by a user.

In a hybrid device, the aerosolizable material may be provided in a cartridge, typically a liquid cartridge. It may be desirable to be able to detach this cartridge from a body portion of the device, and some known hybrid devices allow a cartridge to be detached from a body portion in order to replace or refill the cartridge. For example, the cartridge may be replaced or refilled when the liquid in the cartridge is depleted, or when the user wishes to change the type of liquid being used in the device.

### SUMMARY

According to a first aspect of the present disclosure, there is provided an apparatus for generating an aerosol for inhalation by a user, the apparatus comprising: a first container for containing a liquid from which, in use, the apparatus generates a flow of aerosol; a second container for containing a material through which, in use, the flow of aerosol passes; an aerosol generating arrangement for generating the flow of aerosol from the liquid contained in the first container; and a heating arrangement for heating the material contained in the second container, wherein the heating arrangement is arranged to heat the material contained in the second container to a temperature that prevents or reduces condensation from the flow of aerosol forming on the material and is below a temperature required to cause substantial aerosol formation from the material.

In some embodiments, the heating arrangement is arranged to heat the material contained in the second container to a temperature below 250° C.

In some embodiments, the heater is arranged to heat the second container to a temperature within the range 50-150° C.

In some embodiments, the aerosol generating arrangement is a heater that is arranged to heat liquid from the first container to a temperature in the range 100-300° C.

In some embodiments, the aerosol generating arrangement that is a heater is arranged to heat the liquid from the first container to a temperature in the range 150-250° C.

In some embodiments, the material comprises a susceptor material and the heating arrangement comprises an inductive heating arrangement arranged to generate a magnetic field to induce heating of the susceptor material to heat the material.

In some embodiments, the inductive heating arrangement comprises an induction coil around the second container.

In some embodiments, the material comprises one or more of: flakes of susceptor material interspersed in tobacco material; an elongate susceptor material; and a sheet material.

In some embodiments, the heating arrangement comprises a resistive heating arrangement arranged to transfer heat to the material.

In some embodiments, the apparatus comprises: a body portion; a cartridge comprising the first container and the aerosol generating arrangement; and a mouthpiece assembly comprising the second container and the heating arrangement, wherein the mouthpiece assembly is arranged downstream of the cartridge such that aerosol generated by the cartridge is drawn through the material in the second container by the user drawing on the mouthpiece assembly.

According to a second aspect of the present disclosure, there is provided a method of using an apparatus according to any one of the preceding aspects, the method comprising: using the aerosol generating arrangement to generate a flow of aerosol from the liquid contained in the first container; using the heating arrangement to heat to the material contained in the second container to prevent or reduce condensation of the generated aerosol on the material but without causing any substantial aerosol formation from the material.

In some embodiments, the aerosol generating arrangement is a heating arrangement is arranged to heat the liquid to a temperature in the range 100-300° C.

In some embodiments, the aerosol generating arrangement is arranged to heat the liquid in the first container to a temperature in the range 150-250° C.

In some embodiments, the heating arrangement is arranged to heat the material contained in the second container to a temperature below 250° C.

In some embodiments, the heating arrangement is arranged to heat the second container to a temperature within the range 50-150° C.

### BRIEF DESCRIPTION OF THE DRAWINGS

Embodiments of the disclosure will now be described, by way of example only, with reference to the accompanying drawings, in which:

FIG. 1a is a perspective view of an of an apparatus for generating an aerosol, according to an example.

FIG. 1b is a schematic cross-sectional illustration of the apparatus of FIG. 1a.

FIG. 1c is a cross-sectional view of a mouthpiece assembly, according to an example.

FIG. 2 is a flow diagram illustrating a method of using the apparatus of FIGS. 1a and 1b.

### DETAILED DESCRIPTION OF THE DRAWINGS

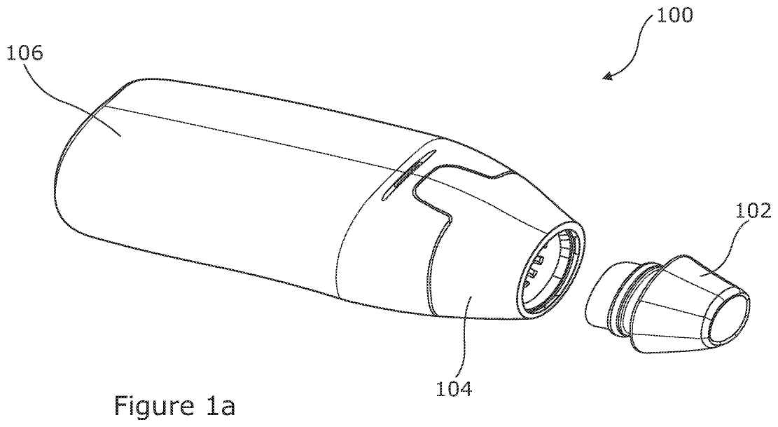

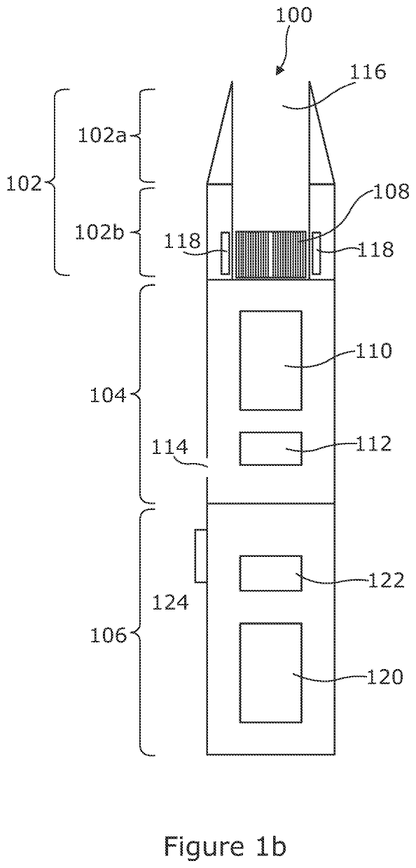

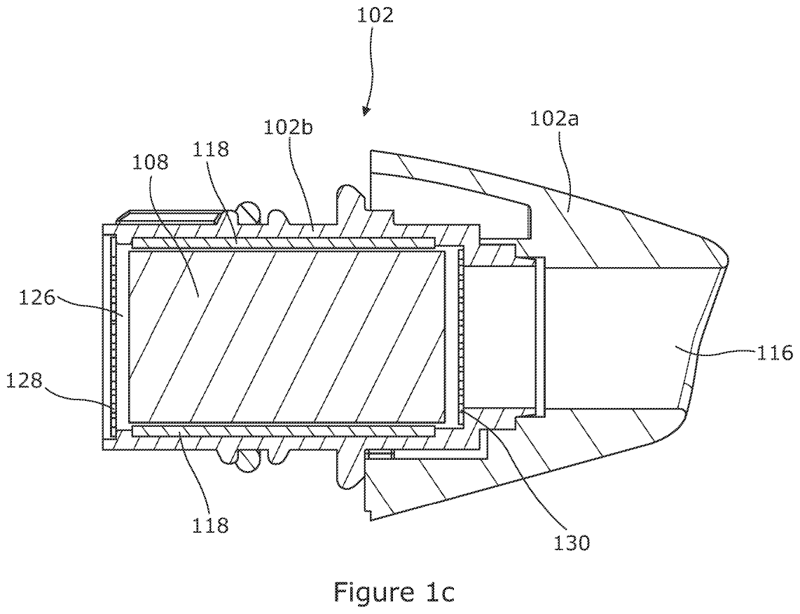

Referring to FIG. 1, a schematic of an aerosol provision device, referred to herein as an apparatus 100 is illustrated. The apparatus 100 is an inhalation device (i.e. a user uses it to inhale an aerosol provided by the system 100). The apparatus 100 is a hand-held device. In this example, the apparatus 100 is an electronic device.

The apparatus 100 comprises the mouthpiece assembly 102, a cartridge 104 and a body portion 106. The apparatus 100 is for heating aerosolizable material, for example an e-liquid, to volatilize at least one component of the aerosolizable material to generate a flow of aerosol for inhalation by a user. In one example, the apparatus 100 may be an electronic cigarette or “e-cigarette”. The mouthpiece assembly 102 may contain a tobacco pod (not shown in FIG. 1) containing a material through which the flow of aerosol flows before being inhaled by the user. In such an example, the apparatus 100 is a so called ‘hybrid device’.

In the example shown in FIG. 1, the mouthpiece assembly 102 is a component separable from (i.e. releasably attached to) the cartridge 104. However, in some examples, the mouthpiece assembly 102 may be integral with the cartridge 104. Similarly, in the example shown in FIG. 1, the cartridge 104 is a component separable from the body portion 106 but in some examples, the body portion 106 may be integral with the cartridge 104.

FIG. 1b is a schematic cross section of the apparatus 100 shown in FIG. 1a. As shown in FIG. 1b, the mouthpiece assembly 102 comprises a mouthpiece 102a for being received in the mouth of a user, and a material container 102b for containing a material 108 that is described in more detail below.

The cartridge 104 comprises aerosolizable material stored in a reservoir 110. The aerosolizable material may be a liquid—for example, an e-cigarette liquid (or “e-liquid”) or any other type of aerosolizable material, such a gel or a solid aerosolizable material. The cartridge 104 comprises an aerosol generating arrangement 112 for generating a flow of aerosol from aerosolizable material supplied from the reservoir 110. In this example, the aerosol generating arrangement 112 is a first heating arrangement 112 that is supplied with electrical power from the power supply in the body portion 106 (described below) to heat aerosolizable material supplied from the reservoir 110. In heating the aerosolizable material volatile components of the aerosolizable material may be released as a vapor. The first heating arrangement 112 may comprise at least one heating element and may comprise at least one wick for supplying liquid from the reservoir 110 to the first heating arrangement 112. The first heating arrangement 112 may be referred to as an ‘atomizer’, and where the cartridge 104 comprises an atomizer, the cartridge 104 may be referred to as a ‘cartomizer’.

In other examples, the aerosol generating arrangement 112 need not be a heating arrangement but may instead comprise other means, for example, a piezo-electric arrangement, for generating the flow of aerosol.

The cartridge 104 also comprises an inlet 114 to allow air to be drawn into the cartridge 104 to carry aerosol and, in at least some examples, components entrained from the material 108 in the mouthpiece assembly 102 out of the apparatus 100 via an outlet 116 provided in the mouthpiece 102a for inhalation by a user (not shown). In at least some examples, the vapor that is produced that then at least partly condenses to form an aerosol before exiting the apparatus 100 through the mouthpiece 102a for inhalation by a user (not shown).

The aerosolizable material in the reservoir 110 can be a liquid, although in some examples, the aerosolizable material may another type of aerosolizable material, such as a gel. For example, the liquid may be aerosolized at temperatures in the range of 100-300° C. or more particularly at temperatures in the range of 150-250° C. Liquids that are aerosolizable at lower temperatures require less heating and therefore may reduce the power consumption of the apparatus 100. Suitable materials include those conventionally used in e-cigarette devices, including for example propylene glycol and glycerol (also known as glycerine). In use, as a user draws on the mouthpiece 102a, air is drawn into the apparatus 100 through one or more air inlets 114.

In use, when a user draws on the mouthpiece 102a, aerosolizable material may be drawn from the reservoir 110 and heated by the first heating arrangement 112 to volatilize components of the aerosolizable material to generate an aerosol which mixes with air flowing from the inlet 114 to produce a flow of aerosol. The flow of aerosol is drawn out of the apparatus 100 through an aperture in the mouthpiece 102a for inhalation by the user.

The aerosolizable material typically contains between 9-25% water (which is present to alter the viscosity of the liquid to allow wicking), and when this is vaporized and passed through the mouthpiece assembly 102, the (heated) water may condense on the (relatively colder) material 108. This may cause the material 108 to get wet which may lead to the problem of the material 108 clumping together and inhibiting flow of the aerosol through the material 108 and ultimately impairing delivery of the aerosol and/or the entrained flavorants to the user.

The material 108 may impart to or modify a property, for example the flavor, of the aerosol before the aerosol passes out of the apparatus 100 for inhalation by a user. The material 108 may, for example, consist of or comprise tobacco. As the aerosol passes through and over the material 108, the aerosol entrains organic and/or other compounds or constituents from the material 108 to impart the flavor of the material 108 to the aerosol.

Examples of the material 108 may include tobacco, tobacco derivatives, expanded tobacco, reconstituted tobacco, ground tobacco, tobacco extract, homogenized tobacco or tobacco substitutes. The material 108 may be in the form of a rod of tobacco, a pod or plug of tobacco, loose tobacco, agglomerates, etc., and may be in relatively dry form or in relatively moist form for example. The material 108 may include other, non-tobacco, products, such as flavorants.

The material 108 may be in the form of extruded tobacco pellets packed into a housing. Spacings between the pellets permit air or an air/aerosol mix to flow through spacings between the pellets to entrain aerosolized material (e.g. flavorants) from the pellets.

In use, the material 108 is heated by heat transfer from the aerosol flow to the material 108 to release components that are entrained in the aerosol. The temperature required to release such components from the material is typically in the range 150° C. to 170° C. However, in addition, and to prevent or reduce condensation of the aerosol on the material 108, the material container 102b comprises a second heating arrangement 118. The second heating arrangement 118 is arranged to heat the material 108 to a temperature below a temperature required to form an aerosol from the material; i.e. without causing any substantial aerosol formation from the material.

In some examples, the second heating arrangement 118 is for heating the material 108 to a temperature in the region of 50 to 150° C. and preferably in the region of 100 to 150° C. to reduce or prevent condensation.

The second heating arrangement 118 may, for example, be an inductive heater. For example, the material 108 may include a susceptor material, such as a metal (e.g. aluminum) that is heated in response to interaction with an alternating electromagnetic field.

The heating arrangement 118 may, for example, include a coil arranged to emit an alternating electromagnetic field that, when interacting with the susceptor material, induces electrical currents in the susceptor material to heat the susceptor material. Heat generated in the susceptor material may be transferred by conduction, convection or radiation to the material 108 in the material container 102b.

In some examples, the heating arrangement 118 may comprise a helical coil wrapped around the material 108. For example, the heating arrangement may comprise a helical coil of substantially flat wire. In some examples, the coil may be formed as layers of arcuate metallic material formed in different layers of a printed circuit board (PCB) structure, wherein each turn of the coil is formed in a separate layer of the PCB structure, with each turn joined at it ends to adjacent turns or to a power supply, and each turn separated along its length from adjacent turns by an electrically insulating material. For example, the turns of the coil may be formed as copper tracks. In other examples, the coil may be formed of other wire arrangements, such as single strand wire or multicore wire (e.g. so-called “Litz” wire). The heating arrangement 118 may comprise an induction coil printed on a PCB. The coil may have any suitable geometry, for example, square, round or oblong.

Using induction heating may be advantageous because, in some examples, the susceptor material is able to heat the material 108 to a required temperature more quickly that can be achieved by resistive heating. Furthermore, in some examples, inductive heating arrangements may be implemented without the need for resistance temperature detectors, and so may be simpler and/or cheaper to manufacture.

In some examples, the material 108 may include flakes of susceptor material interspersed between pellets of tobacco material, for example. In some examples, the susceptor material could be embedded in pellets of tobacco material. In other examples, the susceptor material could be an elongate string of wire (e.g. aluminumwire) wound around or between tobacco material. In other examples, the susceptor material may be formed in a sheet lining an interior of the material container 102b so that the whole material container 102b is heated to a temperature above a temperature at which condensation can occur. The susceptor material may for example comprise a foil e.g. aluminumwrapper that surrounds the material 108.

The susceptor material may in some examples comprise a ferritic material. Ferritic materials may be advantageous because they are efficient at generating heat by electromagnetic induction. In other examples, the susceptor material may be aluminum, copper, or any other material capable of generating heat by electromagnetic induction. For example, the susceptor material may comprise a thin (e.g. 0.5-20 μm thickness) film of aluminum.

In some examples, the second heating arrangement 118 may instead be a resistive heater.

The body portion 106 is for powering and controlling the apparatus 100 and comprises a power supply 120 and a controller 122. The power supply 120 may comprise a battery, for example a disposable battery or a rechargeable battery that may be recharged by connecting the apparatus to an external power supply. For example, the apparatus 100 may comprise a charging port (not shown) such as a USB port arranged to provide electrical current to the power supply 120 to recharge the power supply periodically.

The controller 122 may comprise circuitry (comprising, for example, an integrated circuits) for controlling the operation of various components of the apparatus 100. The controller 122 is arranged to provide electrical power to the first heating arrangement 112 in the cartridge 104 and the second heating arrangement 118 in the material container 102b from the power supply 120 in response to user input received at a user input device 124. The user input device 124 may be, for example, a press switch provided at a surface of the body portion 106, arranged to be pressed by a user of the apparatus 100 when the user intends to inhale aerosolizable material (or alternatively by a puff detector).

In some examples, the second heating arrangement 118 is arranged under the control of the controller 122 to pre-heat the material container 102b prior to the generation of aerosol by the first heating arrangement 112 (i.e. from liquid stored in the reservoir 110), for example, for 1 to 2 seconds before aerosol generation. The second heating arrangement 118 may then continue heating the material container 102b during a user inhalation and then switch off when an inhalation is completed (e.g. as detected by a puff detector or a user releasing a switch of the input device).

FIG. 1c is a cross-section view of the mouthpiece assembly 102 described above with reference to FIG. 1b. As shown in FIG. 1c, the material container 102b comprises a chamber 126 containing the material 108. During manufacture, the material container 102b is formed comprising the chamber 126 and the material 108 is then provided in the chamber 126. The material 108 is enclosed in the chamber 126 by a first barrier 128 enclosing the chamber 126 at or near a first end of the chamber 126 and a second barrier 130 at a second end of the chamber 126. The first barrier 128 and the second barrier 130 each comprise a porous mesh. The mesh allows flow of the aerosol through the chamber 126 (and the material 108) but prevents the material 108 from being lost from the chamber 126; for example, by being inadvertently inhales by the user. The mesh is formed of a heat-resistant material, and is advantageously a heat-conductive material, such as a metal, since this aids in transferring heat to the material 108 in order to release more desired compounds from the material.

The mouthpiece 102a may be formed, for example, from a plastics material, such as polypropylene, by injection molding. The shape of the mouthpiece 102a in the example of FIG. 1a is tapered to provide an ergonomic shape for a user's mouth to contact. The material container 102b may also be formed from a plastics material by injection molding. The material container 102b may for example be formed of polypropylene or of polyethylene terephthalate (PET).

In some examples, rather than the mouthpiece 102a and the material container 102b being separate components, there may be no separate mouthpiece 102a and the material container 102b may function as a mouthpiece.

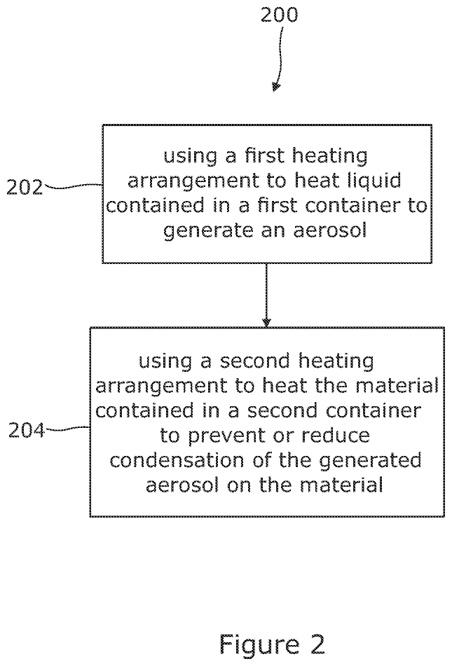

FIG. 2 is a flow diagram illustrating a method of using the apparatus 100 described above with reference to FIGS. 1a to 1c.

At block 202, the first heating arrangement 112 is used to heat the liquid contained in the first container (e.g. the reservoir 110) to generate an aerosol.

At block 204, the second heating arrangement 118 is used to heat to the material 108 contained in a second container (e.g. the material container 102b) to prevent or reduce condensation of the generated aerosol on the material 108.

The above embodiments are to be understood as illustrative examples of the invention. Further embodiments of the invention are envisaged. For example, the material may be omitted from the material chamber, for example at the option of the user. This provides the user with more flexibility over the use of the cartridge as the user can use the cartridge as a classic “e-cigarette” device, only aerosolizing liquid and not having the aerosol pass over or through material, from time to time if they choose.

As used herein, the terms “flavor” and “flavorant” refer to materials which, where local regulations permit, may be used to create a desired taste or aroma in a product for adult consumers. They may include extracts (e.g., licorice/liquorice, hydrangea, Japanese white bark magnolia leaf, chamomile, fenugreek, clove, menthol, Japanese mint, aniseed, cinnamon, herb, wintergreen, cherry, berry, peach, apple, Drambuie™, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

1. An apparatus for generating an aerosol for inhalation by a user, the apparatus comprising:
a first container for containing a liquid from which, in use, the apparatus generates a flow of aerosol;
a second container for containing a material through which, in use, the flow of aerosol passes;
an aerosol generating arrangement for generating the flow of aerosol from the liquid contained in the first container; and
a heating arrangement for heating the material contained in the second container, wherein the heating arrangement is arranged to heat the material contained in the second container to a temperature that prevents or reduces condensation from the flow of aerosol forming on the material and is below a temperature required to cause substantial aerosol formation from the material.

2. The apparatus according to claim 1, wherein the heating arrangement is arranged to heat the material contained in the second container to a temperature below 250° C.

3. The apparatus according to claim 2, wherein the heater is arranged to heat the second container to a temperature within a range of 50-150° C.

4. The apparatus according to claim 1, wherein the aerosol generating arrangement is a heater that is arranged to heat the liquid from the first container to a temperature in a range of 100-300° C.

5. The apparatus according to claim 4, wherein the aerosol generating arrangement is a heater is arranged to heat the liquid from the first container to a temperature in a range of 150-250° C.

6. The apparatus according to claim 1, wherein the heating arrangement comprises an inductive heating arrangement arranged to generate a magnetic field to induce heating of a susceptor material to heat the material.

7. The apparatus according to claim 6, wherein the inductive heating arrangement comprises an induction coil around or at the second container.

8. The apparatus according to claim 6, wherein the material comprises one or more of: flakes of susceptor material interspersed in tobacco material; an elongate susceptor material; and a sheet of susceptor material wrapping the material.

9. The apparatus according to claim 1, wherein the heating arrangement comprises a resistive heating arrangement arranged to transfer heat to the material.

10. The apparatus according to claim 1, further comprising:
a body portion;
a cartridge comprising the first container and the aerosol generating arrangement; and
a mouthpiece assembly comprising the second container and the heating arrangement,
wherein the mouthpiece assembly is arranged downstream of the cartridge such that aerosol generated by the cartridge is drawn through the material in the second container by the user drawing on the mouthpiece assembly.

11. A method of using the apparatus according to claim 1, the method comprising:
using the aerosol generating arrangement to generate the flow of aerosol from the liquid contained in the first container; and
using the heating arrangement to heat the material contained in the second container to prevent or reduce the condensation of the generated aerosol on the material but without causing any substantial aerosol formation from the material.

12. The method according to claim 11, wherein the aerosol generating arrangement is a heating arrangement is arranged to heat the liquid to a temperature in a range of 100-300° C.

13. The method according to claim 12, wherein the aerosol generating arrangement is arranged to heat the liquid in the first container to a temperature in a range of 150-250° C.

14. The method according to claim 1, wherein the heating arrangement is arranged to heat the material contained in the second container to a temperature below 250° C.

15. The method according to claim 14, wherein the heating arrangement is arranged to heat the second container to a temperature within a range of 50-150° C.
